(19) United States
(12) Patent Application Publication
(10) Pub. No.: US 2012/0241038 A1
(43) Pub. Date: Sep. 27, 2012

(54) AIRFLOW GUIDE COVER ASSEMBLY

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/189,582

(22) Filed: Jul. 25, 2011

(30) Foreign Application Priority Data
Mar. 25, 2011 (CN) 201110073006.8

(51) Int. Cl. F16L 9/22

(52) U.S. Cl. 138/155

(57) ABSTRACT

An airflow guide cover assembly includes a first airflow guide cover, and a second airflow guide cover. The first airflow guide cover defines a groove in an inner surface around a rear end of the first airflow guide cover, and a number of recesses in a rear end of an outer surface of the first airflow guide cover. A flange extends forwards from a front end of an inner surface of the second airflow guide cover, to engage in the groove of the first airflow guide cover. A number of blocks protrudes forwards from a front end of an outer surface of the second airflow guide cover, to engage in the corresponding recesses of the first airflow guide cover. The airflow guide cover assembly is modular, the airflow guide covers can be assembled to suit any situation where it's required.

### BACKGROUND

1. Technical Field

The present disclosure relates to an airflow guide cover assembly.

2. Description of Related Art

An electronic device, such as a computer, generally includes an airflow guide which covers a heat-generating component, and a fan arranged at an end of the airflow guide cover, to dissipate the heat produced by the heat-generating component. However, the length of the airflow guide cover is fixed, and airflow guiding covers with different lengths must be made in accordance with the particular heat dissipating requirement of different electronic devices.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an assembled, isometric view of an embodiment of an airflow guide cover assembly.

FIG. 2 is an exploded, isometric view of FIG. 1, but inverted.

FIG. 3 is an exploded isometric view of the device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

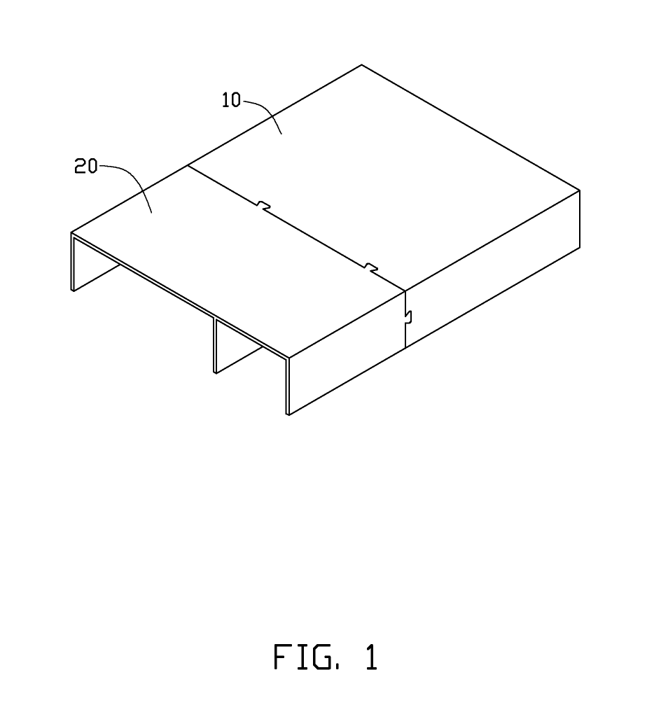

Referring to FIG. 1, an embodiment of an airflow guide cover assembly includes a first airflow guide cover 10, and a second airflow guide cover 20.

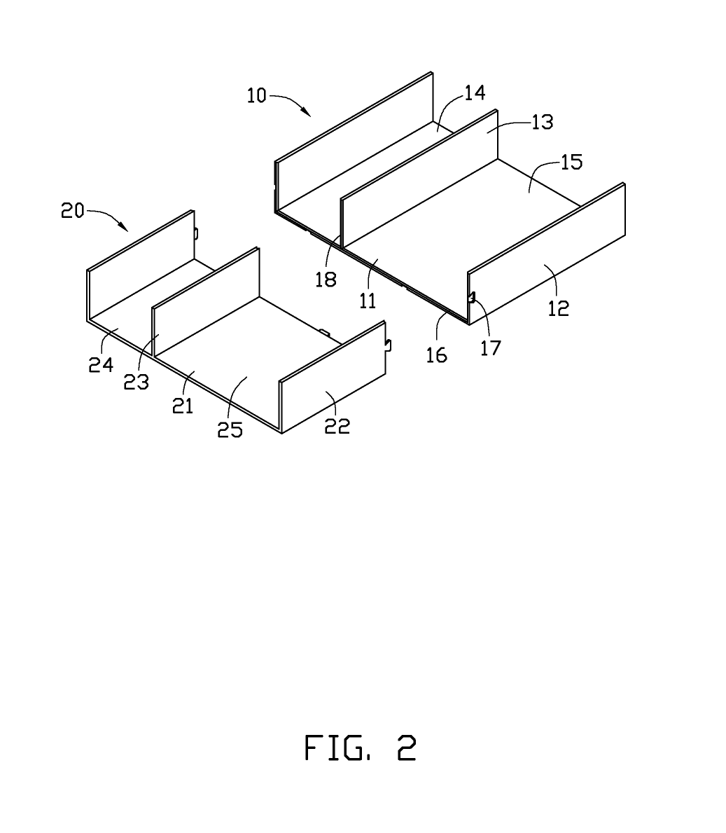

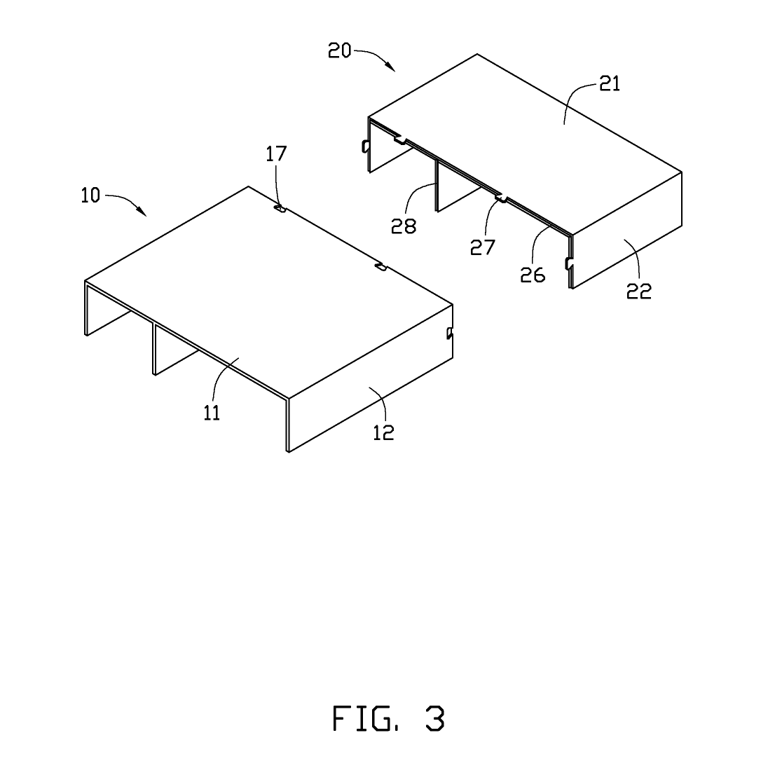

Referring to FIGS. 2 and 3, the first airflow guide cover 10 includes a first top wall 11, two first sidewalls 12 perpendicularly extending down from opposite ends of the first top wall 11, and a first partition sheet 13 extending down from a bottom of the first top wall 11 between and parallel to the first sidewalls 12. A first channel 14 is bounded by the first partition sheet 13, the first top wall 11, and one of the first sidewalls 12. A second channel 15 is bounded by the first partition sheet 13, the first top wall 11, and the other first sidewall 12. A groove 16 with a slanted bottom is defined in the inner surfaces of the first top wall 11 and the first sidewalls 12 around a rear end of the first airflow guide cover 10. The outer surfaces of the first top wall 11 and the first sidewalls 12 at the rear end each define a substantially trapezoidal recess 17 extending through the rear end of the first airflow guide cover 10. The width of each recess 17 gradually decreases in a rearward direction. A protrusion 18 having a substantially V-shaped cross-section longitudinally extends from a rear end of the first partition sheet 13.

The second airflow guide cover 20 includes a second top wall 21, two second sidewalls 22 perpendicularly extending down from opposite ends of the second top wall 21, and a second partition sheet 23 extending down from a bottom of the second top wall 21 between and parallel to the second sidewalls 22. A third channel 24 is bounded by the second partition sheet 23, the second top wall 21, and one of the second sidewalls 22. A fourth channel 25 is bounded by the second partition sheet 23, the second top wall 21, and the other second sidewall 22. A slanted flange 26 extends forwards from the front ends of the second top wall 21 and the second sidewalls 22. The flange 26 is adjacent to the inner surfaces of the second top wall 21 and the second sidewalls 22. A substantially trapezoidal block 27 protrudes forwards from the front end of an outer surface of each of the second top wall 21 and the second sidewalls 12. The width of each block 27 gradually increases in a forward direction. A groove 28 having a substantially V-shaped cross-section is longitudinally defined in a front end of the second partition sheet 23.

Referring to FIG. 1, in assembly, the second airflow guide cover 20 is connected to the rear end of the first airflow guide cover 10. The flange 26 and the blocks 27 of the second airflow guide cover 20 are respectively engaged in the groove 16 and the recesses 17 of the first airflow guide cover 10. The protrusion 18 of the first airflow guide cover 10 is engaged in the groove 28 of the second airflow guide cover 20. Thereby, the airflow guide cover assembly is assembled and presents an almost complete hermetic seal. The first and second channels 14 and 15 of the first airflow guide cover 10 are aligned with the third and fourth channels 24 and 25 of the second airflow guide cover 20.

According to different heat dissipation needs, the first airflow guide cover 10 and the second airflow guide cover 20 can be detached from each other and used individually, or serially connected to form the airflow guide cover assembly which is required.

Even though numerous characteristics and advantages of the embodiments have been set forth in the foregoing description, together with details of the structure and the functions of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An airflow guide cover assembly, comprising:
a first airflow guide cover defining a first groove in an inner surface around a rear end of the first airflow guide cover, and a plurality of recesses in a rear end of an outer surface of the first airflow guide cover; and
a second airflow guide cover detachably connected to the first airflow guide cover, a flange extending forwards from a front end of an inner surface of the second airflow guide cover, to engage in the first groove of the first airflow guide cover, and a plurality of blocks protruding forwards from a front end of an outer surface of the second airflow guide cover, to engage in the corresponding recesses of the first airflow guide cover.

2. The airflow guide cover assembly of claim 1, wherein the first airflow guide cover comprises a first top wall, and two first sidewalls perpendicularly extending down from opposite ends of the first top wall, the plurality of recesses are respectively defined in rear ends of outer surfaces of the first top wall and the first sidewalls, the second airflow guide cover comprises a second top wall, and two second sidewalls perpendicularly extending down from opposite ends of the second top wall, the plurality of blocks respectively extend from front ends of outer surfaces of the second top wall and the second sidewalls.

3. The airflow guide cover assembly of claim 2, wherein each of the recesses and blocks is substantially trapezoid-shaped, the width of each recess gradually decrease in a rearward direction, and the width of each block gradually increase in a forward direction.

4. The airflow guide cover assembly of claim 2, wherein the first airflow guide cover further comprises a first partition sheet extending down from a bottom of the first top wall between and parallel to the first sidewalls, a protrusion having a substantially V-shaped cross-section longitudinally extends from a rear end of the first partition sheet, the second airflow guide cover further comprises a second partition sheet extending down from a bottom of the second top wall between and parallel to the second sidewalls, a second groove having a substantially V-shaped cross-section is longitudinally defined in a front end of the second partition sheet, to receive the protrusion of the first partition sheet.
